(19) United States
(12) Patent Application Publication
(10) Pub. No.: US 2015/0319407 A1
(43) Pub. Date: Nov. 5, 2015

(54) INTERCOM SYSTEM UTILIZING WI-FI

(71) Applicant: CloudTalk LLC, Bala Cynwyd, PA (US)

(72) Inventors: Jonathan Frankel, Bala Cynwyd, PA (US); Isaac Levy, New York, NY (US)

(21) Appl. No.: 14/699,124

(22) Filed: Apr. 29, 2015

Related U.S. Application Data
(60) Provisional application No. 61/988,804, filed on May 5, 2014.

(51) Int. Cl. H04N 7/14; G06K 9/00; H04L 29/06

(52) U.S. Cl. CPC H04N 7/14; H04L 65/607; H04L 65/608; G06K 9/00335

(57) ABSTRACT

Responsive to a processor of a first intercom unit establishing a wireless data channel with one or more second intercom units of a plurality of intercom units in a wireless network, and responsive to an encoder of the first intercom unit repeatedly encoding, during a repeated time interval, data to be transmitted to the one or more second intercom units over the wireless data channel while pausing the wireless data channel such that the first intercom unit does not transmit the encoded data during the repeated time interval, the processor may receive an indication to un-pause the wireless data channel. A network controller of the first intercom unit may wirelessly transmit the data last encoded by the encoder during the repeated time interval to the one or more second intercom units.

### CROSS-REFERENCE TO RELATED APPLICATIONS

This application claims the benefit of U.S. Provisional Patent Application No. 61/988,804, filed May 5, 2014, the disclosure of which is incorporated herein by reference in its entirety.

### TECHNICAL FIELD

The present invention relates generally to wireless intercom systems, and more particularly, to a wireless intercom system comprising a plurality of intercom station units configured in a mesh network and employing WiFi (IEEE 802.11) wireless protocols.

### BACKGROUND

Intercom systems have been employed to help facilitate communication throughout premises such as a home or office. Using an intercom, one can talk or listen among multiple locations. Current intercom systems can be divided into two categories—wireless and wired. Each possesses serious disadvantages.

Wireless intercom systems rely on simple wireless broadcast technology to broadcast a signal from one handset to all other handsets. Some models permit a user to select which channel to broadcast on, but an associated receiver needs to be set to the same channel in order to receive the broadcasted message. These simple wireless devices suffer from poor quality (due to radio wave interference from other devices and weak signals) and have no privacy or security; anyone can listen in on transmissions by monitoring the channel.

Wired intercom systems are hard-wired together, either via telephone lines or Ethernet cables. These systems are mounted in place in the wall, and communicate with each other through their wired analog or digital connections. These systems provide greater reliability and privacy than wireless intercoms because of their wired connection, but quality is often poor because of interference from power lines. In addition, many wired intercom systems employ a “master/slave” model in which communication is permitted between master and slave devices but two slave devices cannot communicate with each other. Finally, these systems are costly due to the requirement to wire them together.

### SUMMARY

The above-described problems are addressed and a technical solution is achieved in the art by providing a wireless intercom system that employs WiFi. A processor of a first intercom unit may establish a wireless data channel with one or more second intercom units of a plurality of intercom units in a wireless network. In an example, the first intercom unit may establish the wireless data channel using the Web real time communication (WebRTC) protocol and the wireless network may be an IEEE 802.11 compatible (WiFi) network.

An encoder of the first intercom unit may repeatedly encode, during a repeated time interval, data to be transmitted to the one or more second intercom units over the wireless data channel while pausing the wireless data channel such that the first intercom unit does not transmit the encoded data during the repeated time interval.

Responsive to the processor of a first intercom unit establishing a wireless data channel with the one or more second intercom units of the plurality of intercom units in the wireless network, and responsive to the encoder of the first intercom unit repeatedly encoding, during a repeated time interval, data to be transmitted to the one or more second intercom units over the wireless data channel while pausing the wireless data channel such that the first intercom unit does not transmit the encoded data during the repeated time interval, the processor may ping, over the wireless network during each repeated time interval, each intercom unit of the plurality of intercom units. The processor may receive an indication to un-pause the wireless data channel. A network controller of the first intercom unit may wirelessly transmit the data last encoded by the encoder during the repeated time interval to the one or more second intercom units. In an example, the data to be transmitted or data to be received may be one or both of audio data and video data. The data last encoded by the encoder during the time interval may be transmitted to the one or more second intercom units using an asynchronous protocol (e.g., user datagram protocol (UDP)). In an example, the data may be encrypted.

If the data last encoded is not the last data encoded for a transmission session, then the network controller of the first intercom unit may continue to wirelessly transmit a set of encoded data last encoded by the encoder to the one or more second intercom units. If the data last encoded is the last data encoded for a transmission session, then processing returns to said repeatedly encoding, said pinging, said receiving an indication, and said transmitting.

In an example, the processor of the first intercom unit may establish a wireless data channel to all intercom units of the plurality of intercom units in the wireless network. The first intercom unit and the one or more second intercom units may be associated with a mesh network of intercom units.

The processor of a first intercom unit establishing a wireless data channel may further comprise the processor transmitting over a Wi-Fi module of the first intercom unit, one or more probe requests to discover in-range WiFi networks. The processor may receive one or more probe responses by corresponding one or more access points (AP). In an example, the one or more probe requests and the one or more probe responses may comprise an exchange of at least one of a wireless network name (SSID), supported data rates, or encryption type.

The processor may associate with compatible access points (AP's), which may be other intercom station units. The processor may initiate a mesh repeater functionality to permit the first intercom unit to behave as an access point. In an example, the processor associating with compatible access points (e.g., other intercom station units) may further comprise the processor attempting low-level WiFi authentication with compatible AP's.

In an example, the processor may determine that a third intercom unit (of the plurality of intercom units) is functioning as a repeater and is more compatible with respect to proximity and signal strength than other available AP's. Accordingly, the processor may switch wirelessly transmitting the data last encoded to the third intercom unit.

In an example, a microphone and a speech recognition unit of the first intercom unit may recognize received data as speech data. Responsive to recognizing the speech data as a voice command, the processor may execute the voice command. In another example, responsive to an audio analyzer of the first intercom unit determining that the intercom unit is on a call with one or more other intercom units, the processor may transmit, using an audio encoder, the speech data to one or more other intercom units. In another example, responsive to the microphone and the audio analyzer unit of the first intercom unit determining the received data to be an event has been triggered, then the processor may broadcast, using the audio encoder, the received data to all other intercom units of the plurality of intercom units.

In an example, a camera and a motion detector of the first intercom unit may detect the received data as a visual gesture. Accordingly, the processor may execute a command corresponding to the detected visual gesture. In another example, a camera and a video encoder of the first intercom unit may detect the received data as video data. Responsive to the processor of the first intercom unit determining that the first intercom unit is on a call with one or more other intercom units, the processor may transmit, using the video encoder, the video data to one or more other intercom units.

The above-described problems are addressed and a technical solution is achieved in the art by providing a wireless intercom unit. The wireless intercom unit may comprise a memory and a processor operatively coupled to the memory, the processor configured to: responsive to establishing a wireless data channel with one or more second intercom units of a plurality of intercom units in a wireless network, and responsive to an encoder coupled to the processor repeatedly encoding, during a repeated time interval, data to be transmitted to the one or more second intercom units over the wireless data channel while pausing the wireless data channel such that the processor does not transmit the encoded data during the repeated time interval, receive an indication to un-pause the wireless data channel. The processor may wirelessly transmit, using a network controller coupled to the processor, the data last encoded by the encoder during a repeated time interval to the one or more second intercom units.

In an example, the processor may be further configured to ping over the wireless network during each repeated time interval, each intercom unit of the plurality of intercom units. In an example, the processor may establish the wireless data channel using the Web real time communication (WebRTC) protocol. The wireless network may be a WiFi network.

### BRIEF DESCRIPTION OF THE DRAWINGS

The present invention will be more readily understood from the detailed description of exemplary embodiments considered in conjunction with the following drawings, of which:

FIG. 1 is a block diagram illustrating an example intercom station unit.

FIG. 2 is a block diagram illustrating an example network of intercom station units configured to communicate with each other using a WiFi access point (AP).

FIG. 3 is a message sequence diagram illustrating messages exchanged between intercom station units in the network and the backend server when an intercom station unit joins and operates in the network of intercom station units.

FIG. 4 is a combined block and flow diagram illustrating how audio packets may be analyzed by the intercom station unit (for speech or pattern recognition) before transmitting the audio packets.

FIG. 5 is a combined block and flow diagram illustrating how video packets may be analyzed by the intercom station unit (for motion detection and gestures recognition) before transmitting the video packets.

FIG. 6 is a message sequence diagram illustrating messages exchanged between intercom station units in the network and an access point when the intercom station units initiates communication over the network.

FIG. 7 is a flow diagram illustrating an example of a method for permitting a wireless intercom station unit to communicate with other intercom station units in a mesh network employing a wireless protocol.

### DETAILED DESCRIPTION

Embodiments of the present disclosure comprise a wireless intercom system composed of discrete station units that communicate with each other through Wi-Fi (802.11) technology. Each station unit may comprise several mechanisms for recording information, including a camera, microphone, and touch-screen, as well as several mechanisms for communicating information to the user, including a graphical display and speakers. These station units may communicate with each other and non-station unit devices over the wireless network.

Communication within the intercom system may comprise one or more of the following methods: a peer-to-peer setup such as Wi-Fi Direct, using a router to coordinate local area network traffic, using a router and an Internet connection to communicate over a wide area network, using a mesh network, or using wired Ethernet. An intercom connection may be initialized and controlled using, for example, the interactive connectivity establishment (ICE) protocol, which may direct the communication over a session traversal utilities for network address translation (STUN) server or traversal using relays around network address translation (TURN) server depending on the type of router, firewall, and connection employed. The intercom connection may also be initialized and controlled by using the session initiation protocol (SIP) and transmitted via the real-time transport protocol (RTP).

Each intercom system may be comprised of discrete station units grouped together into a mesh-configured network. There may be no dedicated central command device separate from the individual station units. The settings of the intercom system as a whole and of the station units collectively or individually may be set from any one of the station units or from a computing device that is not part of the intercom system, such as a user's personal computer or mobile phone.

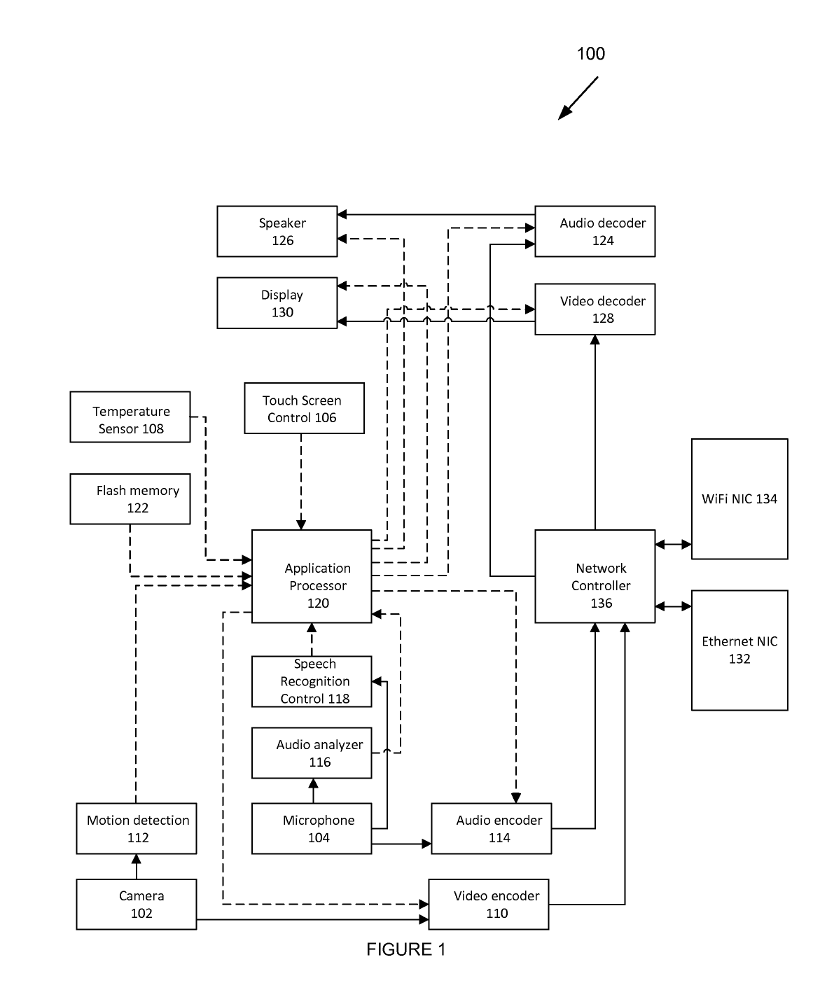

FIG. 1 is a block diagram illustrating an example intercom station unit 100. Input devices associated with the intercom station unit 100 may include one or more of a video camera 102, a microphone 104, a touch-screen 106, and various sensors including, for example, a temperature sensor 108. Video data captured by the camera 102 may be pre-processed by a video encoder 110 and a motion detector 112. Audio data captured by the microphone 104 may be pre-processed by an audio encoder 114, an audio analyzer 116, and a speech recognition controller 118. Data received from input devices, including the video encoder 110, motion detector 112, audio encoder 114, audio analyzer 116, speech recognition controller 118, the touch screen 106, and the temperature sensor 108, may be further processed by an application processor 120. The application processor 120 reads data and programs from and writes processed data to a memory 122, which may be, but is not limited to, a flash memory and/or a hard disk drive or solid state disk drive.

Audio data processed by the application processor 120 may be decoded by an audio decoder 124 for output to one or more speakers 126. Video data processed by the application processor 120 may be decoded by a video decoder 128 for output to a display 130. The application processor 120 may transmit to or receive data from a wired network over an Ethernet network interface card (NIC) 132 and/or over a wireless (e.g., WiFi) network interface card (NIC) 134, the Ethernet NIC 132 and the WiFi NIC 134 both under the control of a network controller 136.

Other devices not shown but associated with the intercom station unit 100 may include antennas, USB ports, and Ethernet ports. The intercom station unit 100 may also comprise one or more of the following: a wireless repeater to strengthen a building's wireless connection; a Power Over Ethernet (PoE) adapter to connect with other units; a separate antenna (such as Zigbee or Z-Wave) to interact with other home appliances; and multiple sensors, such as a smoke detector, moisture sensor, and other atmospheric or environmental sensors.

The intercom station unit 100 may be powered by one or more of the following: a battery; a plug connected to a power outlet; a hard-wired connection with the building's electrical power supply; or power over Ethernet.

The intercom station unit 100 may have one or more physical privacy shutters that enable the user to cover either or both of the video camera 102 and the microphone 104 to prevent remote users from hearing or seeing the intercom station unit's transmissions.

The intercom station unit 100 may be wall-mounted by placing it directly on a wall or on a swiveling mount that permits the user to direct the intercom station unit 100 in a particular direction. The swiveling mount may be locked firmly in place to prevent movement when touched by a user. The intercom station unit 100 may be mounted under a cabinet or placed upright on a flat surface. The video camera 102 of the intercom station unit 100 may also be tilted vertically and horizontally, independently of the position of the intercom station unit 100.

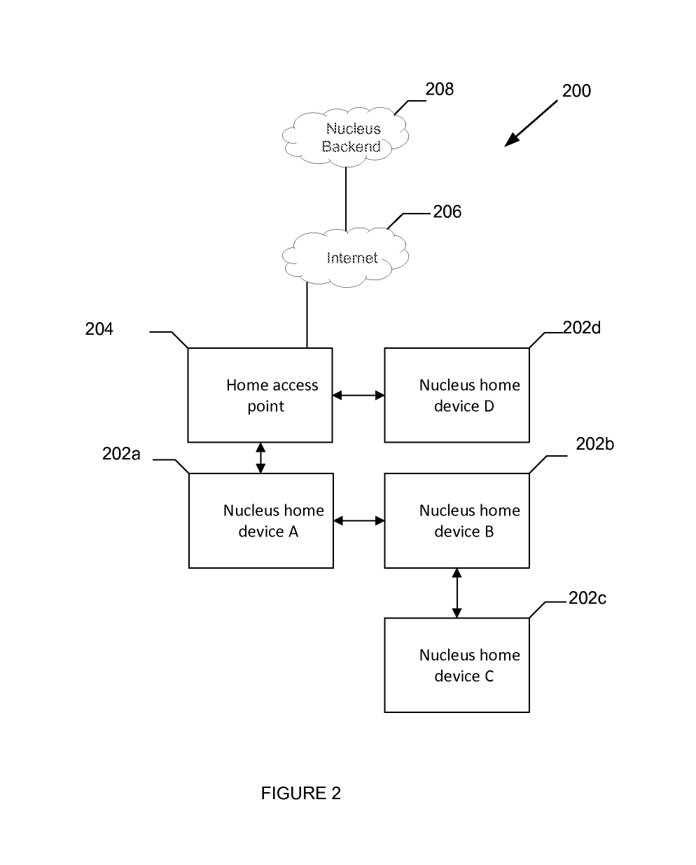

While mechanical buttons may be employed in the intercom station unit 100, in one example, users may interact with the intercom station unit 100 via the graphical user interface (not shown). FIG. 2 is a block diagram illustrating an example network 200 of intercom station units 202a-202n configured to communicate with each other using a WiFi access point (AP) 204. The AP 204 may be configured to communicate with other networks of intercom station units in other locations over the Internet 206 using configuration information provided by a backend server 208. The main graphical user interface may display a graphical representation of each of the intercom station units 202a-202n in the network 200 of intercom station units 202a-202n as well as additional information. The graphical representation of each intercom station unit 202a-202n may be in the form of an icon, text, static picture, live video stream, or an image taken by a camera of a remote station unit (e.g., 202b-202n) at preset intervals. The representation of each intercom station unit 202a-202n may also include indications of the status (i.e. “on” or “off”) of input and output capabilities of an intercom station unit (e.g., 202a), such as cameras, microphones, and speakers. The representation of each of the intercom station units 202a-202n may also include an indication of the communication status between a local intercom station unit (e.g., 202a) and a remote intercom station unit (e.g., 202b) (e.g., is a local intercom station unit (e.g., 202a) currently communicating with the remote intercom station unit (e.g., 202b)). The representation of each intercom station unit (e.g., 202a) may also include a graphical indication of the current sound level at a location of a remote station unit (e.g., 202b-202n). Additional displayable information may include time, weather, calendar appointments, stocks, music playing, room temperature, or other information that may be relevant to the user.

Users can initiate communication with remote station units (e.g., 202b-202n) by selecting single or multiple remote station units (e.g., 202b-202n), or by selecting an on-screen button that initiates communication with all remote station units (e.g., 202b-202n). The user can select different modes of communication, including audio-only, video-only, or audio and video, and each mode can be mono-directional or bi-directional.

Any intercom station unit (e.g., 202a) in the network 200 may communicate directly with all other intercom station units (e.g., 202b-202n) in the same network 200. Communication may be one-to-one, one-to-many, or many-to-many. No intercom station unit outside the network 200 may communicate with any intercom station unit (e.g., 202a) inside the network 200 unless permission is granted. Permission may be granted by one or more administrators associated with each intercom network. The one or more administrators control the permissions for that network. In one example, the administrator that may first create a new network may need to create an administrator account in order to do so. The one or more administrators may then approve other units (including an application associated with the network running on a phone or tablet) to join the network.

Communication may be one-directional (monitoring) or bi-directional, or, if communicating with multiple intercom station units, any combination of one-directional and bi-directional. Communication may be via audio, video, text, data, and images. Communication between intercom station units 202a-202n may be initiated by voice activation or by touch such as by a single tap on the touch-screen 106. Once communication is initiated, one user may interact with users of other intercom station units (e.g., 202b-202n). Users may terminate the communication via voice activation or by touch such as a single tap on the touch-screen 106 of the intercom station unit (e.g., 202a).

Users may initiate communication with remote intercom station units (e.g., 202b-202n) by selecting single or multiple remote station units (e.g., 202b-202n), or by selecting an on-screen button that initiates communication with all remote station units (e.g., 202b-202n). The user can select different modes of communication, including audio-only, video-only, or audio and video, and each mode can be mono-directional or bi-directional.

Intercom station units (202a-202n) may participate in multiple networks (e.g., “home” and “work”), while other intercom station units in those networks may only see the station units within their own network (e.g., other intercom station units 202a-202n in the “home” network cannot see the station units in the “work” network unless permission is explicitly granted).

Users may control the privacy settings for each intercom station unit (e.g., 202a-202n) and their relationship with other intercom station units (e.g., 202a-202n). Users may control which other intercom station units (e.g., 202a-202n) may see their video, hear their audio, see their current sound level, or monitor them (e.g., the user may listen and watch the intercom station unit (e.g., 202a) of the user without broadcasting the user's intercom station unit's own sound or video). Users may also control which remote intercom station units (e.g., 202b-202n) may instantly communicate with a local intercom station unit (e.g., 202a), and which intercom station units (e.g., 202a-202n) need to request access each time they do so. Users may toggle their own input and output settings, such as turning one or more of the camera 102, the microphone 104, and the speakers 126 on and off. For further privacy and security, audio and video communications may be encrypted using standard Wi-Fi encryption protocols.

The intercom station unit (e.g., 202a) may also be provided with an application programming interface (API) for third-party developers to develop applications that may run as part of the user interface. Such applications may run exclusively on the intercom station unit (e.g., 202a), or may interface with other intercom station units (e.g., 202b-202n) via a Wi-Fi or Zigbee or Z-Wave wireless connection. For example, the intercom station unit (e.g., 202a) may be configured to control thermostats, HVAC units, or wireless speakers either through user input or automatically through preset macros.

An intercom station unit (e.g., 202a) may be configured to learn about its environment and user preferences organically, and adjust settings accordingly. For example, the intercom station unit (e.g., 202a) may detect that the user adjusts certain settings at a set time every weekday, and begin adjusting those settings automatically. The intercom station unit (e.g., 202a) may proactively notify the user of certain events as well as record the events using the video camera 102 or the microphone 104 (either on a hard drive or in an online cloud associated with the intercom station unit (e.g., 202a)). For example, an intercom station unit (e.g., 202a) may transmit an email or a push notification to a user's mobile phone in the event that intercom station unit (e.g., 202a) detects sound or motion, or if the room temperature increases above or decreases below a certain threshold. The user can adjust the settings to make the detection more or less sensitive. Sound- or motion-detection may also be employed as a security mechanism. For example, each intercom station unit 202a-202n in the network 200, or a user-selected subset of intercom station units 202a-202n, may issue audible and visual alerts if motion or noise is detected in a specific room or rooms.

An intercom station unit (e.g., 202a) may comprise power-saving mechanisms to reduce energy consumption. The screen brightness and power can be manually adjusted by the user, and may also be automatically adjusted in response to certain events. For example, a screen that has been turned off may be automatically turned on when an incoming communication is detected. The intercom station unit (e.g., 202a) may also detect a loss of power in the home and react accordingly. For example, if the intercom station unit (e.g., 202a) detects a loss of power, all intercom station units (e.g., 202a-202n) within the house may turn their screens on brightly to provide emergency lighting.

The intercom station unit (e.g., 202a) may warn users, using verbal alerts, spoken commands, and flashing lights, about impending extreme weather or climate events utilizing alerts from the National Weather Service or other provider of climate alerts.

The audio and video streams recorded by each intercom station unit (e.g., 202a-202n) may be saved onto a local hard drive or an online “cloud” storage drive. The audio and video can be retrieved, searched, and downloaded in digital form. The audio and video may be saved in encrypted form.

The intercom station unit (e.g., 202a) may have a built-in or third-party digital wallet, containing credit card, bank account, and other payment information, and allow a user to make simple purchases directly from the intercom station unit (e.g., 202a).

The intercom station unit (e.g., 202a) may be configured to receive advertisements and to serve advertisements to other intercom station units (e.g., 202b-202n). The advertisements may be targeted based on geolocation, demographic, or household data. The advertisements may be static “banner ads” or interactive advertisements that make use of the intercom station unit's video camera 102, microphone 104, and speakers 126.

When an intercom station unit (e.g., 202a) is initially added to the intercom network 200, the intercom station unit (e.g., 202a) may be configured, in one example, to create a Web real-time communications (WebRTC) connection to all other intercom units (e.g., 202b-202n) in the network 200 using an access point 204 over the network 200 (e.g., the Internet 206). This initial, one-time connection may take a few seconds as the intercom station units (e.g., 202a-202n) exchange IP addresses, ports, etc., over the network 200. Once the intercom station unit (e.g., 202a) has been initialized, the intercom station unit (e.g., 202a) may be configured to employ WebRTC's built-in data channel to keep the connection constantly alive, pinging all other intercom station units (e.g., 202a-202n) on the network 202 constantly to make sure they are still in communication with the intercom station unit 202a. The intercom station unit (e.g., 202a) may be configured to employ WebRTC's built-in audio and video channels, but may be configured to be paused so that the audio and video channels are not actually transmitting data.

The microphone 104 and the video camera 102 of the intercom station unit 202a may be on and encoding the last few milliseconds of data.

When User A begins a call, the intercom station unit 202a may be configured to transmit a signal via the already-open WebRTC data channel to User B. The signal may be an indication to “un-pause audio and/or video channels”. As would be appreciated by those skilled in the art, WebRTC employs asynchronous protocols (UDP) for even faster transmission times.

Since (a) the audio/video have already been encoded and (b) the audio and video channels have previously been initialized, as soon as those channels are un-paused, the intercom station unit 202a may begin transmitting the just encoded audio and video packets over the un-paused audio and video channels to another intercom station unit (e.g., 202b). Instead of seconds for the first audio/video packets to be received, the first audio/video packets may be received in <200 milliseconds.

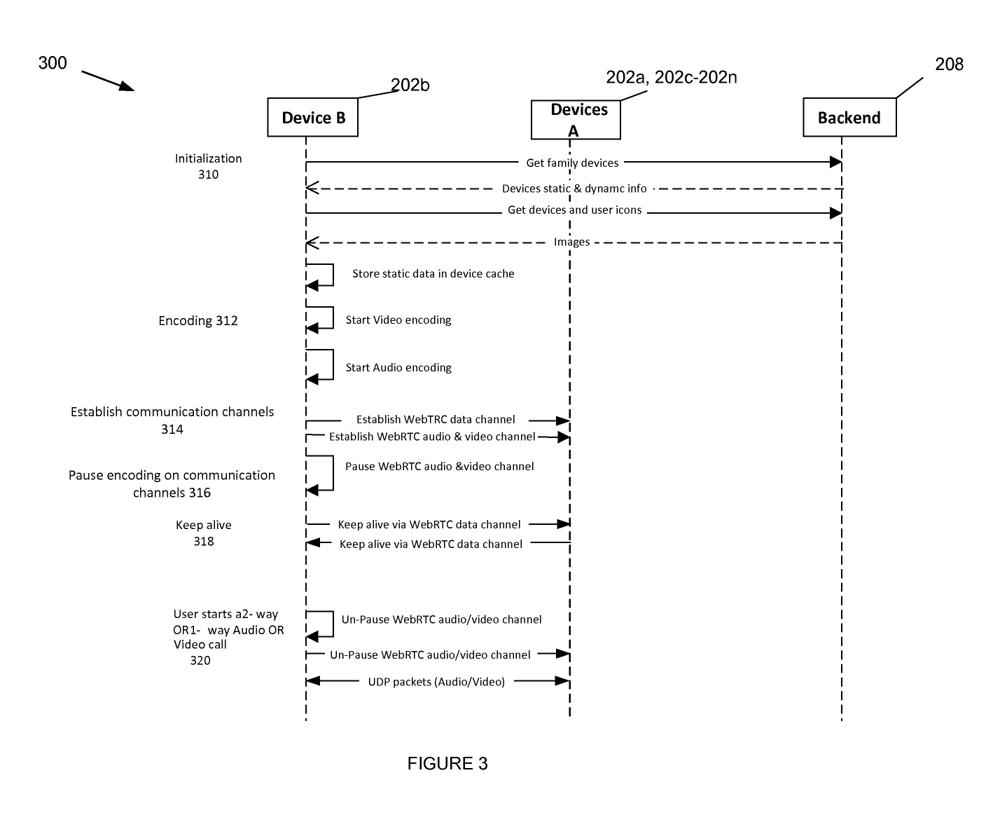

FIG. 3 is a message sequence diagram illustrating messages exchanged between intercom station units (e.g., 202a-202n) in the network 200 and the backend server 208 when an intercom station unit 202b (e.g., Device B) joins and operates in the network 200 of intercom station units 202a, 202c-202n (e.g., Devices A). During an initialization phase 310, the intercom station units (e.g., 202a-202n) exchange configuration data with each other using the backend server 208 using the access point 204 over the Internet 206. Exchanged data may include, but is not limited to, device family data, static and dynamic device information, the names and icons of the devices in the network 200, and initial images. During an encoding phase 312, the intercom station unit 202b may store static data in a device cache, begin video encoding, and begin audio encoding local input video and audio, respectively. During an establish communication channels phase 314, the intercom station unit 202b may establish WebRTC data channels with each of the other intercom station units (e.g., 202a, 202c-202n) in the network 200, then open WebRTC video and audio channels with each of the other intercom station units (e.g., 202a, 202c-202n) in the network 200. During an establish communication channels phase 314, the intercom station unit 202b may establish a WebRTC data channel, audio channel, and video channel with each of the other intercom station units (e.g., 202a, 202c-202n) in the network 200. During a pause encoding on communications channels phase 316, the intercom station unit 202b may pause the WebRTC audio and video channels. Encoding video and audio data received locally continues at repeated intervals, but the data is not processes by the application processor 120. During a keep alive phase 318, the intercom station unit 202b may keep alive the WebRTC data channels, audio channels, and video channels to the other intercom station units (e.g., 202a, 202c-202n) in the network 200 by, for example, pinging each of the other intercom station units (e.g., 202a, 202c-202n) in the network 200. If a user starts a 2-way or 1-way audio or video call phase 320, the intercom station unit 202b may un-pause the WebRTC audio and video channels of the intercom station unit 202b and send a message to each of the other intercom station units (e.g., 202a, 202c-202n) in the network 200 to un-pause their WebRTC audio and video channels. The intercom station unit 202b may then exchange audio and video packets (e.g., asynchronous UDP packets) with each of the other intercom station units (e.g., 202a, 202c-202n) in the network 200.

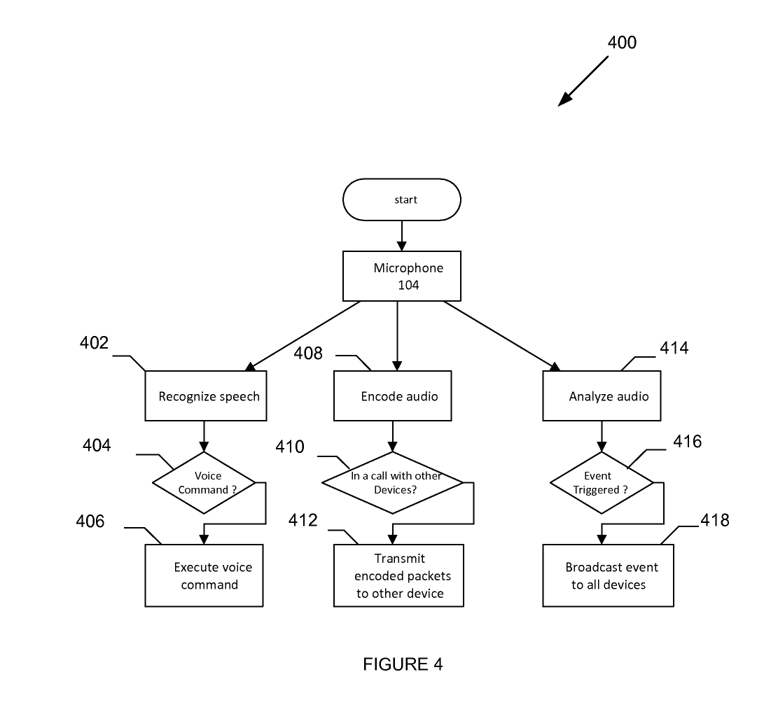

FIG. 4 is a combined block and flow diagram illustrating how audio packets may be analyzed by the intercom station unit (e.g., 202a) (for speech or pattern recognition) before transmitting the audio packets. Audio data may be recorded by the microphone 104. The audio data may be passed on to each of the audio encoder 114, the audio analyzer 116, and the speech recognition controller 118.

At block 402, the speech recognition controller 118 attempts to recognize the audio data as speech. If, at block 404, the speech recognition controller 118 recognizes the audio data as speech, and the speech data corresponds to a voice command, then at block 406, the application processor 120 may execute the voice command. At block 408, the audio encoder 114 encodes the audio data. If, at block 410, the application processor 120 determines that the intercom station unit (e.g., 202a) is in a call with a second intercom station unit (e.g., 202b), then at block 412, the application processor 120 transmits the encoded audio packets to the second intercom station unit (e.g., 202b). At block 414, the audio analyzer 116 analyzes the received audio data. If, at block 416, the audio analyzer 116 and the application processor 120 determine that an event has been triggered, then at block 418, the application processor 120 broadcasts the event to all other intercom station units (e.g., 202b-202n).

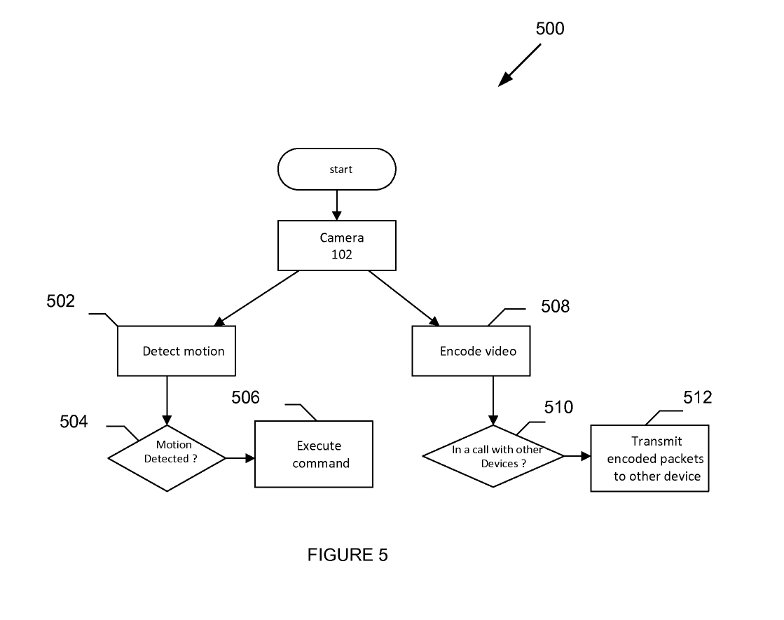

FIG. 5 is a combined block and flow diagram illustrating how video packets may be analyzed by the intercom station unit (e.g., 202a) (for motion detection and gestures recognition) before transmitting the video packets. Video data may be recorded by the video camera 102. The video data may be passed on to the motion detection unit 112 and the video encoder 110.

At block 502, the motion detection unit 112 attempts to recognize the video data as detected motion of one or more objects. If, at block 504, the motion detection unit 112 recognizes the video data as detected motion of one or more objects, then at block 506, the application processor 120 may execute a command. At block 508, the video encoder 110 encodes the video data. If, at block 510, the application processor 120 determines that the intercom station unit (e.g., 202a) is in a call with another intercom station unit (e.g., 202b), then at block 512, the application processor 120 may transmit the encoded video packets to the other intercom station unit (e.g., 202b).

Each of the intercom station units 202a-202n in the network 200 may be configured with a Wi-Fi NIC 134 that can act either in host mode (similarly to tablet computers, which communicate directly with a router) or in bridge mode (and act as a wireless repeater, passing along packets to a further device). In an example, an intercom station unit (e.g., 202a) in the network 200 may transmit probe requests to discover 802.11 networks within its proximity. Probe requests advertise the supported data rates and 802.11 capabilities such as 802.11n of the intercom station unit (e.g., 202a). Because the probe request is sent from the intercom station unit (e.g., 202a) to the destination layer-2 address and BSSID of ff:ff:ff:ff:ff:ff all AP's that receive, the AP's will respond. AP's receiving the probe request check to see if the intercom station unit (e.g., 202a) has at least one common supported data rate. If the intercom station unit (e.g., 202a) has compatible data rates, a probe response is transmitted from an AP advertising the SSID (wireless network name), supported data rates, encryption types if required, and other 802.11 capabilities of the AP.

The intercom station unit (e.g., 202a) chooses compatible networks from the probe responses it receives. Compatibility may be based on encryption type. Once compatible networks are discovered, the intercom station unit (e.g., 202a) may attempt low-level 802.11 authentication with compatible AP's. Once the intercom station unit (e.g., 202a) determines which AP it would like to associate to (which may be another intercom station unit (e.g., 202b)), the intercom station unit (e.g., 202a) may transmit an association request to that AP. The association request contains chosen encryption types if required and other compatible 802.11 capabilities. Once the intercom station unit (e.g., 202a) establishes an 802.11 connection, the intercom station unit (e.g., 202a) may initiate its repeater functionality and may act as an AP. In an example, during this process, the intercom station unit (e.g., 202a) may automatically determine that another intercom station unit (e.g., 202b) that is functioning as a repeater is more compatible due to proximity and signal strength then other available AP's, and, accordingly, associate with and transmit data to the other intercom station unit (e.g., 202b).

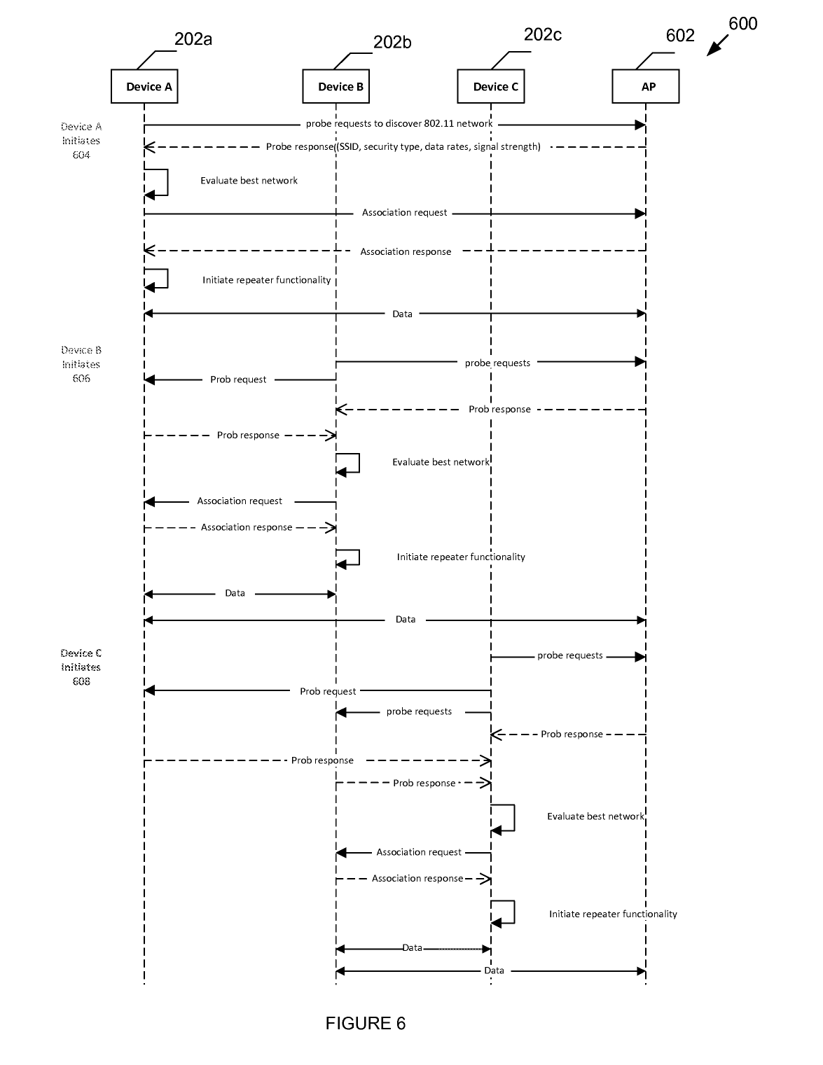

FIG. 6 is a message sequence diagram illustrating messages exchanged between intercom station units (e.g., 202a-202c) in the network 200 and an access point 602 when the intercom station units (e.g., 202a-202c) initiates communication over the network 200. In an example, in a Device A (intercom station unit 202a) initialization phase 604, the intercom station unit 202a may initiate communication with the access point 602 by issuing a probe request to discover 802.11 networks. The access point 602 may transmit a probe response with an SSID, security type, data rates, and signal strength indications. The intercom station unit 202a may evaluate the best 802.11 network, and may determine that the best response came from the access point 602. The intercom station unit 202a may issue an association request with the access point 602, to which the access point 602 may reply with an affirmative association response. The intercom station unit 202a may initiate its own 802.11 repeater functionality, and may exchange data packets with the access point 602.

In an example, in a Device B (intercom station unit 202b) initialization phase 606, the intercom station unit 202b may initiate communication with the access point 602 by issuing a probe request to discover 802.11 networks to the access point 602 and the intercom station unit 202a. The access point 602 and the intercom station unit 202a may transmit probe responses to the intercom station unit 202b. The intercom station unit 202b may evaluate the best 802.11 network, and may determine that the best response came from the intercom station unit 202a. The intercom station unit 202b may issue an association request with the intercom station unit 202a, to which the intercom station unit 202a may reply with an affirmative association response. The intercom station unit 202b may initiate its own 802.11 repeater functionality, and may exchange data packets with the intercom station unit 202a and the access point 602.

In an example, in a Device C (intercom station unit 202c) initialization phase 608, the intercom station unit 202c may initiate communication with the access point 602 by issuing a probe request to discover 802.11 networks to the access point 602 and the intercom station units 202a and 202b. The access point 602 and the intercom station units 202a, 202b may transmit probe responses to the intercom station unit 202c. The intercom station unit 202b may evaluate the best 802.11 network, and may determine that the best response came from the intercom station unit 202a. The intercom station unit 202b may issue an association request with the intercom station unit 202b, to which the intercom station unit 202b may reply with an affirmative association response. The intercom station unit 202c may initiate its own 802.11 repeater functionality, and may exchange data packets with the intercom station unit 202b and the access point 602.

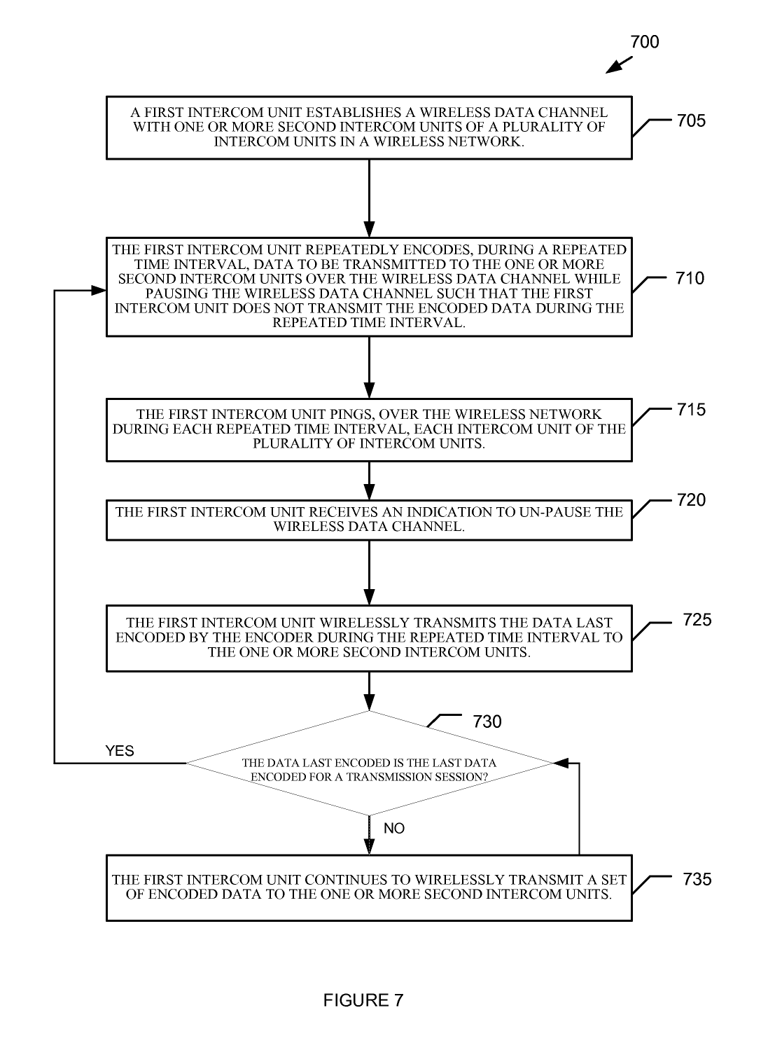

FIG. 7 is a flow diagram illustrating an example of a method 700 for permitting a wireless intercom station unit to communicate with other intercom station units in a mesh network employing a wireless protocol. The method 800 may be performed by a computer system 100 of FIG. 1 and may comprise hardware (e.g., circuitry, dedicated logic, programmable logic, microcode, etc.), software (e.g., instructions run on a processing device), or a combination thereof. In one example, the method 100 may be performed by components of the intercom station unit 100 of FIG. 1 or a wireless intercom unit (e.g., 202a) of FIG. 2.

As shown in FIG. 7, at block 705, a processor 120 of a first intercom unit (e.g., 100, 202a) may establish a wireless data channel with one or more second intercom units (e.g., 202b-202n) of a plurality of intercom units (e.g., 202a-202n) in a wireless network (e.g., 200). In an example, the first intercom unit (e.g., 100, 202a) may establish the wireless data channel using the Web real time communication (WebRTC) protocol. In an example, the wireless network (e.g., 200) may be an IEEE 802.11 compatible (WiFi) network.

At block 710, an encoder (e.g., 110, 114) of the first intercom unit (e.g., 100, 202a) may repeatedly encode, during a repeated time interval, data to be transmitted to the one or more second intercom units (e.g., 202b-202n) over the wireless data channel while pausing the wireless data channel such that the first intercom unit (e.g., 100, 202a) does not transmit the encoded data during the repeated time interval.

Responsive to the processor 120 of a first intercom unit (e.g., 100, 202a) establishing a wireless data channel with the one or more second intercom units (e.g., 202b-202n) of the plurality of intercom units (e.g., 202a-202n) in the wireless network (e.g., 200), and responsive to the encoder (e.g., 110, 114) of the first intercom unit (e.g., 110, 114) repeatedly encoding, during a repeated time interval, data to be transmitted to the one or more second intercom units (e.g., 202b-202n) over the wireless data channel while pausing the wireless data channel such that the first intercom unit does not transmit the encoded data during the repeated time interval, at block 715, the processor 120 may ping, over the wireless network (e.g., 200) during each repeated time interval, each intercom unit (e.g., 202b-202n) of the plurality of intercom units (e.g., 202a-202n). At block 720, the processor 120 may receive an indication to un-pause the wireless data channel. At block 725, a network controller 136 of the first intercom unit (e.g., 100, 202a) may wirelessly transmit the data last encoded by the encoder (e.g., 110, 114) during the repeated time interval to the one or more second intercom units (e.g., 202b-202n). In an example, the data to be transmitted or data to be received may be one or both of audio data and video data. The data last encoded by the encoder (e.g., 110, 114) during the time interval may be transmitted to the one or more second intercom units (e.g., 202b-202n) using an asynchronous protocol (e.g., UDP). In an example, the data may be encrypted.

If, at block 730, the data last encoded is not the last data encoded for a transmission session, then at block 735, the network controller 136 of the first intercom unit (e.g., 100, 202a) may continue to wirelessly transmit a set of encoded data last encoded (e.g., 110, 114) by the encoder to the one or more second intercom units (e.g., 202b-202n). If, at block 730, the data last encoded is the last data encoded for a transmission session, then processing returns to block 710, wherein said repeatedly encoding, said pinging, said receiving an indication, and said transmitting are repeated.

In an example, the processor 120 of the first intercom unit (e.g., 100, 202a) may establish a wireless data channel to all intercom units (e.g., 202b-202n) of the plurality of intercom units (e.g., 202a-202n) in the wireless network 200. The first intercom unit (e.g., 100, 202a) and the one or more second intercom units (e.g., 202b-202n) may be associated with a mesh network of intercom units.

In an example, the processor 120 of a first intercom unit (e.g., 100, 202a) establishing a wireless data channel may further comprise the processor 120 transmitting over a Wi-Fi module 134 of the first intercom unit (e.g., 100, 202a), one or more probe requests to discover in-range WiFi networks. The processor 120 may receive one or more probe responses by corresponding one or more access points (AP's). In an example, the one or more probe requests and the one or more probe responses may comprise an exchange of at least one of a wireless network name (SSID), supported data rates, or encryption type.

The processor 120 may associate with compatible access points (AP's), which may be other intercom station units. The processor 120 may initiate a mesh repeater functionality to permit the first intercom unit (e.g., 100, 202a) to behave as an access point. In an example, the processor 120 associating with compatible access points (e.g., other intercom station units) may further comprises the processor 120 attempting low-level WiFi authentication with compatible AP' s.

In an example, the processor 120 may determine that a third intercom unit (e.g., 202c) of the plurality of intercom units (e.g., 202a-202n) is functioning as a repeater and is more compatible with respect to proximity and signal strength than other available AP's. Accordingly, the processor 120 may switch wirelessly transmitting the data last encoded to the third intercom unit (e.g., 202c).

In an example, a microphone 104 and a speech recognition unit 118 of the first intercom unit (e.g., 100, 202a) may recognize received data as speech data. Responsive to the processor 120 recognizing the speech data as a voice command, the processor 120 may execute the voice command. In another example, responsive to an audio analyzer 116 of the first intercom unit (e.g., 100, 202a) determining that the intercom unit (e.g., 100, 202a) is on a call with one or more other intercom units (e.g., 202b-202n), the processor 120 may transmit, using an audio encoder 114, the speech data to one or more other intercom units (e.g., 202b-202n). In another example, responsive to the microphone 104 and the audio analyzer unit 116 of the first intercom unit (e.g., 100, 202a) determining the received data to be an event has been triggered, the processor 120 may broadcast, using the audio encoder 114, the received data to all other intercom units (e.g., 202b-202n) of the plurality of intercom units (202a-202n).

In an example, a camera 102 and a motion detector 112 of the first intercom unit may detect the received data as a visual gesture. Accordingly, the processor 120 may execute a command corresponding to a detected visual gesture. In another example, a camera 102 and a video encoder 110 of the first intercom unit (e.g., 100, 202a) may detect the received data as video data. Responsive to the processor 120 of the first intercom unit (e.g., 100, 202a) determining that the first intercom unit (e.g., 100, 202a) is on a call with one or more other intercom units (e.g., 202b-202n), the processor 120 may transmit, using the video encoder 110, the video data to one or more other intercom units (e.g., 202b-202n).

The algorithms and displays presented herein are not inherently related to any particular computer or other apparatus. Various general purpose systems may be used with programs in accordance with the teachings herein, or it may prove convenient to construct a more specialized apparatus to perform the required method steps. Example structure for a variety of these systems appears from the description herein. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
responsive to a processor of a first intercom unit establishing a wireless data channel with one or more second intercom units of a plurality of intercom units in a wireless network, and
responsive to an encoder of the first intercom unit repeatedly encoding, during a repeated time interval, data to be transmitted to the one or more second intercom units over the wireless data channel while pausing the wireless data channel such that the first intercom unit does not transmit the encoded data during the repeated time interval,
receiving, by the processor, an indication to un-pause the wireless data channel; and
wirelessly transmitting, by a network controller of the first intercom unit, the data last encoded by the encoder during the repeated time interval to the one or more second intercom units.

2. The method of claim 1, further comprising pinging, by the processor over the wireless network during each repeated time interval, each intercom unit of the plurality of intercom units.

3. The method of claim 1, wherein the first intercom unit establishes the wireless data channel using the Web real time communication (WebRTC) protocol.

4. The method of claim 1, wherein the wireless network is a WiFi network.

5. The method of claim 1, further comprising the processor of the first intercom unit establishing a wireless data channel to all intercom units of the plurality of intercom units in the wireless network.

6. The method of claim 1, wherein the first intercom unit and the one or more second intercom units are associated with a mesh network of intercom units.

7. The method of claim 1, wherein the data to be transmitted or data to be received are one or both of audio data and video data.

8. The method of claim 1, wherein the data last encoded by the encoder during the time interval is transmitted to the one or more second intercom units using an asynchronous protocol.

9. The method of claim 1, wherein the data is encrypted.

10. The method of claim 1, wherein the processor of a first intercom unit establishing a wireless data channel further comprises:
transmitting, by the processor over a Wi-Fi module of the first intercom unit, one or more probe requests to discover in-range WiFi networks;
receiving, by the processor, one or more probe responses by corresponding with one or more intercom units functioning as access points (AP's);
associating with, by the processor, a compatible access point from the one or more intercom units functioning as access points (AP's); and
initiating, by the processor, a mesh repeater functionality to permit the first intercom unit to behave as an access point.

11. The method of claim 10, wherein associating with, by the processor, a compatible access point from the one or more intercom units functioning as access points (AP' s) further comprises attempting, by the processor, low-level WiFi authentication with the one or more intercom units functioning as access points (AP's).

12. The method of claim 10, wherein the one or more probe requests and the one or more probe responses comprises an exchange of at least one of a wireless network name (SSID), supported data rates, or encryption type.

13. The method of claim 10, further comprising:
determining, by the processor, that a third intercom unit of the plurality of intercom units is functioning as a repeater and is more compatible with respect to proximity and signal strength than other available AP's; and
switching, by the processor, said wirelessly transmitting the data last encoded to the third intercom unit.

14. The method of claim 1, further comprising, recognizing, by a microphone and a speech recognition unit of the first intercom unit, received data as speech data.

15. The method of claim 14, further comprising:
recognizing, by the processor, the speech data as a voice command; and
executing the voice command.

16. The method of claim 14, wherein, responsive to an audio analyzer of the first intercom unit determining that the intercom unit is on a call with one or more other intercom units,
transmitting, by the processor using an audio encoder, the speech data to one or more other intercom units.

17. The method of claim 1, further comprising, determining, by a microphone and an audio analyzer unit of the first intercom unit, the received data as an event having been triggered.

18. The method of claim 17, wherein, responsive to the audio analyzer of the first intercom unit determining that an event has been triggered,
broadcasting, by the processor using an audio encoder, the received data to all other intercom units of the plurality of intercom units.

19. The method of claim 1, further comprising:
detecting, by a camera and a motion detector of the first intercom unit, the received data as a visual gesture; and
executing a command corresponding to a detected visual gesture.

20. The method of claim 1, wherein:
detecting, by a camera and a video encoder of the first intercom unit, the received data as video data;
responsive to the processor of the first intercom unit determining that the first intercom unit is on a call with one or more other intercom units,
transmitting, by the processor using the video encoder, the video data to one or more other intercom units.
